(19) United States
(12) Patent Application Publication
(10) Pub. No.: US 2006/0192870 A1
(43) Pub. Date: Aug. 31, 2006

(54) Solid-state imaging device and driving method therefor

(75) Inventors: Makoto Shoho, Tenri-shi (JP); Keiichiro Kagawa, Ikoma-shi (JP); Jun Ohta, Nara-shi (JP)

Correspondence Address: EDWARDS & ANGELL, LLP, P.O. BOX 55874, BOSTON, MA, 02205, US

(73) Assignees: Sharp Kabushiki Kaisha, Osaka (JP); Nara Institute of Science and Technology, Nara (JP)

(21) Appl. No.: 11/355,588

(22) Filed: Feb. 15, 2006

(30) Foreign Application Priority Data
Feb. 15, 2005 (JP) P2005-037998

(51) Int. Cl. H04N 5/335

(52) U.S. Cl. 348/294; 345/100

(57) ABSTRACT

Regarding the solid-state imaging device and the driving method therefor, each picture cell includes a photoelectric conversion portion, a capacitive element, a comparator portion, a reset portion and a select switch element. A control voltage application portion applies a first control voltage to a control line during a signal charging period to make a voltage of the output terminal of the photoelectric conversion portion deviate from the transition region of the comparator portion and applies a second control voltage to the control line during a signal reading period to bring the voltage of the output terminal of the photoelectric conversion portion into the transition region of the comparator portion. A load device that serves as a common load for the comparator portions of picture cells is connected between a signal line and a power source of a prescribed electric voltage.

### CROSS-REFERENCE TO RELATED APPLICATIONS

This Nonprovisional application claims priority under 35 U.S.C. §119(a) on Patent Application No(s). 2005-037998 filed in Japan on Feb. 15, 2005, the entire contents of which are hereby incorporated by reference.

### BACKGROUND OF THE INVENTION

The present invention relates to a solid-state imaging device and a driving method therefor and relates, in particular, to a pulse width modulation type solid-state imaging device that outputs a signal corresponding to incident light as a pulse width signal and a driving method therefor.

Conventionally, as a solid-state imaging device that outputs a signal corresponding to incident light as a pulse width signal, the pulse width modulation type solid-state imaging device shown in FIG. 8 is known (refer to, for example, JP S58-179068 A). The pulse width modulation type solid-state imaging device has a picture cell constructed of a photodiode 101, a reset transistor 102 for resetting the photodiode 101 and a comparator 103 for detecting a threshold value. The comparator 103 has an input terminal connected to a cathode terminal 101a of the photodiode 101. Moreover, the comparator 103 has an output terminal connected to a counter circuit 105, and the counter circuit 105 is connected to a vertical signal line 107 via a vertical select transistor 106.

By photoelectrically converting the incident light by the photodiode 101, an output voltage Vpd outputted to the cathode terminal 101a varies as shown in the timing chart of FIG. 9. When the output voltage Vpd reaches a prescribed reference voltage Vt, an output signal Vout-op of the comparator 103 is inverted.

In the solid-state imaging device, when a reset signal ΦRST is made H (high) level, the reset transistor 102 is turned on and the output voltage Vpd of the photodiode 101 is reset to a reset voltage VPD. Next, by making the reset signal ΦRST have L (low) level, the photodiode 101 starts charging of a signal charge. Since the photodiode 101 generates a signal charge by photoelectric conversion, an electric potential at the cathode terminal 101a of the photodiode 101 is lowered in accordance with the quantity of incident light. Then, at a time when the electric potential (output voltage Vpd) at the input terminal of the comparator 103 reaches the reference voltage Vt, the output signal Vout-op of the comparator 103 changes from H level to L level.

A time t×0 during which the photodiode 101 has started the charging of the signal charge and the output voltage Vpd reaches the reference voltage Vt corresponds to the quantity of the signal charge generated through photoelectric conversion by the photodiode 101.

During a period in which the output signal Vout-op of the comparator 103 has H level, the counter circuit 105 performs count operation. By the count operation, the counter circuit 105 performs analog-to-digital conversion in the picture cell, and a digital value obtained through the analog-to-digital conversion is outputted during a reading period.

### SUMMARY OF THE INVENTION

In the conventional pulse width modulation type solid-state imaging device, the comparator 103 is normally constructed of at least two transistors of a p-channel type MOS transistor 131 and an n-channel type MOS transistor 132 as shown in FIG. 10. Accordingly, there is a problem that the conventional pulse width modulation type solid-state imaging device has many constituent elements, and a real reduction is difficult.

An object of the present invention is to provide a solid-state imaging device capable of reducing the area by simplifying the constituent elements and a driving method therefor.

In order to solve the problem, the solid-state imaging device of the present invention comprises:

a plurality of picture cells arranged; and

a signal line, which is provided in common to the picture cells and from which a signal from each of the picture cells is outputted, wherein each of the picture cells comprises:

a photoelectric conversion portion that photoelectrically converts incident light;

a capacitive element connected between an output terminal of the photoelectric conversion portion and a control line;

a comparator portion, which compares an output voltage of the photoelectric conversion portion with a prescribed reference voltage and outputs an output signal that represents a result of the comparison;

a reset portion, which is connected to the output terminal of the photoelectric conversion portion and discharges a signal charge generated by the photoelectric conversion portion; and

a select switch element, which is connected between an output terminal of the comparator portion and the signal line and becomes conductive when the picture cell is selected, and

the device comprises:

a control voltage application portion, which applies a first control voltage to the control line during a signal charging period to make a voltage of the output terminal of the photoelectric conversion portion deviate from a transition region of the comparator portion and applies a second control voltage to the control line during a signal reading period to bring the voltage of the output terminal of the photoelectric conversion portion into the transition region of the comparator portion; and

a load device, which is connected between the signal line and a power source of a prescribed voltage and serves as a common load for the comparator portions of the picture cells.

It is noted that the “transition region” of the comparator portion means the region between the high level and the low level that the output signal of the comparator portion can take.

In the solid-state imaging device of the present invention, the load device, which serves as a common load for the comparator portions of the picture cells, is connected between the signal line and the power source of a prescribed voltage aside from the picture cells. This therefore obviates the need for including a load for the comparator portion in each picture cell, and the picture cell construction is simplified. As a result, it becomes possible to reduce the area of the solid-state imaging device. Although the comparator in the picture cell has been constructed of, for example, two MOS transistors in the prior art example, one transistor and two wiring lines can be reduced in each picture cell if the comparator portion is constructed of one MOS transistor according to the present invention.

In another aspect, the solid-state imaging device of the present invention comprises:

a plurality of picture cells arranged; and

a signal line, which is provided in common to the picture cells and from which a signal from each of the picture cells is outputted, wherein

each of the picture cells comprises:

a photoelectric conversion portion that photoelectrically converts incident light;

a capacitive element whose one end is connected to a control line;

a transfer switch element, which is connected between the other end of the capacitive element and an output terminal of the photoelectric conversion portion and made conductive to select the photoelectric conversion portion;

a comparator portion, which is connected to the other end of the capacitive element and compares an output voltage of the photoelectric conversion portion received via the transfer switch element with a prescribed reference voltage and outputs an output signal that represents a result of the comparison;

a reset portion, which is connected to the output terminal of the photoelectric conversion portion and discharges a signal charge generated by the photoelectric conversion portion;

a select switch element, which is connected between an output terminal of the comparator portion and the signal line and becomes conductive when the picture cell is selected, and

the device comprises:

a control voltage application portion, which applies a first control voltage to the control line during a signal charging period to make a voltage of the output terminal of the photoelectric conversion portion deviate from a transition region of the comparator portion and applies a second control voltage to the control line during a signal reading period to bring the voltage of the output terminal of the photoelectric conversion portion into the transition region of the comparator portion, and

the capacitive element, the comparator portion, the reset portion and the select switch element are common to the prescribed number of picture cells arranged along the signal line.

In the solid-state imaging device of the present invention, the capacitive element, the comparator portion, the reset portion and the select switch element are common to the prescribed number of picture cells arranged along the signal line. Therefore, the constituent elements can be reduced, and the areal reduction of the solid-state imaging device becomes possible as a whole.

Moreover, in a driving method for driving the solid-state imaging device of the present invention, the select switch element common to the prescribed number of picture cells is turned on for a prescribed period and the transfer switch element for the prescribed number of picture cells is simultaneously turned on within the period in order to output the output signal from the prescribed number of picture cells onto the signal line.

According to the driving method for driving the solid-state imaging device of the present invention, an image signal averaged between the prescribed number of picture cells can be obtained, and signal reading can be performed in a short time in comparison with the method of successively temporarily turning on the transfer switch element. Therefore, reading speed of one frame can be increased by image compression.

The solid-state imaging device of one embodiment comprises:

a pulse width modulation portion, which obtains a pulse width modulation signal by subjecting the output signal outputted from each of the picture cells onto the signal line to analog-to-digital conversion.

In the solid-state imaging device of the one embodiment, the pulse width modulation signal corresponding to the quantity of incident light of the photoelectric conversion portion is obtained.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a diagram showing the construction of a picture cell owned by a solid-state imaging device of a first embodiment of the present invention;

FIG. 2 is a diagram schematically showing the construction of the solid-state imaging device of the first embodiment;

FIG. 3 is a chart for explaining the operation timing of the solid-state imaging device of the first embodiment;

FIG. 4 is a diagram showing the construction of a picture cell owned by a solid-state imaging device of a second embodiment of the present invention;

FIG. 5 is a chart for explaining the operation timing of the solid-state imaging device of the second embodiment;

FIGS. 6A through 6E are diagrams showing the potential profile at each time during the operation of the solid-state imaging device of the second embodiment;

FIG. 7 is a chart for explaining the operation timing by the driving method of the solid-state imaging device of the third embodiment of the present invention;

FIG. 8 is a diagram showing the construction of a picture cell owned by a conventional solid-state imaging device;

FIG. 9 is a chart for explaining the operation timing of the conventional solid-state imaging device; and

FIG. 10 is a diagram illustrating the construction of the comparator in the picture cell of the conventional solid-state imaging device.

### DETAILED DESCRIPTION OF THE INVENTION

The present invention will be described in detail below by the embodiments shown in the drawings.

### First Embodiment

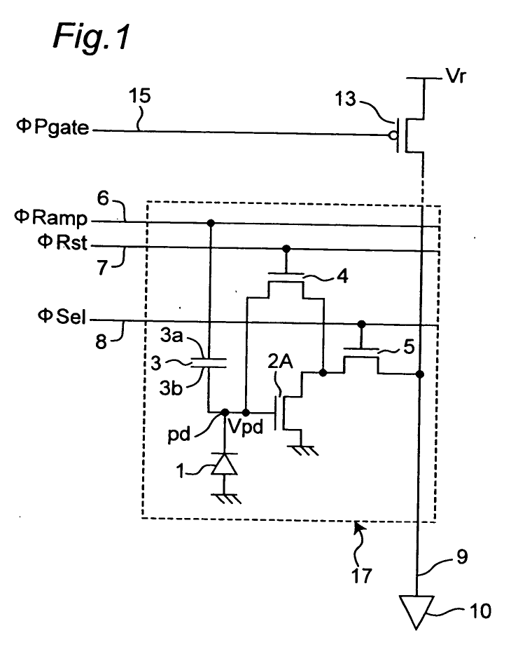

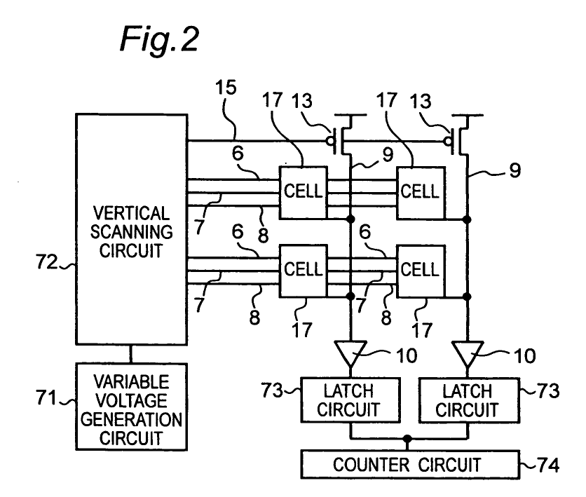

FIG. 2 schematically shows the construction of the pulse width modulation type solid-state imaging device of the first embodiment of the present invention, and FIG. 1 shows in detail the construction of one picture cell of the solid-state imaging device. It is noted that FIG. 2 shows only the picture cells of two rows by two columns among a plurality of picture cells 17 arranged in a matrix form owned by the solid-state imaging device.

As shown in FIG. 1, the picture cell 17 of the solid-state imaging device has a photodiode 1 as the photoelectric conversion portion, a capacitor 3 as the capacitive element, an n-channel type MOS transistor (hereinafter referred to as a “comparator transistor”) 2 as the comparator portion, an n-channel type MOS transistor (hereinafter referred to as a “reset transistor”) 4 as the reset portion and an n-channel type MOS transistor (hereinafter referred to as a “select transistor”) 5 as the select switch element.

A cathode electrode as the output terminal of the photodiode 1 is connected to one end 3b of the capacitor 3 and forms a node pd. The node pd is connected to the gate as the input terminal of the comparator transistor 2A. The other end 3a of the capacitor 3 is connected to a horizontal control line 6 as the control line. The horizontal control line 6 is connected to a variable voltage generation circuit 71 as the control voltage application portion described later.

The drain as the output terminal of the comparator transistor 2A is connected to the drain of the select transistor 5. The reset transistor 4 is connected between the gate and the drain of the comparator transistor 2A. The gate of the reset transistor 4 is connected to a reset select line 7, to which a reset pulse ΦRst is applied. The reset transistor 4 concurrently has a function to effect offset compensation of the comparator transistor 2A and a reset function to reset the electric potential of the photodiode 1.

The source of the select transistor 5 is connected to a vertical signal line 9 as the signal line, and the gate of the select transistor 5 is connected to a row select signal line 8, to which a row select pulse ΦSel is applied.

Moreover, the vertical signal line 9 is connected to the input terminal of a column comparator 10. A p-channel type MOS transistor (hereinafter referred to as a “load transistor”) 13 as a load device that operates as the load of the comparator transistor 2A is connected between the vertical signal line 9 and the power source (voltage: Vr). The gate of the load transistor 13 is connected to a source grounded amplifier bias signal line 15, to which a source grounded amplifier bias voltage ΦPgate is applied. The comparator transistor 2A and the load transistor 13 constitute a source grounded amplifier when the select transistor 5 is on.

As shown in FIG. 2, the load transistor 13 is provided in common to the picture cells 17 of an identical column, i.e., in common to the comparator transistors 2A of a plurality of picture cells 17 arranged along an identical signal line 9.

When a sufficiently high voltage is applied to the gate of the select transistor 5 and the transistor is operating in the linear region of the transistor, the comparator transistor in the picture cell produces a similar function even if the load transistor is located in the picture cell 17 or on the vertical signal line 9. That is, no change occurs in the function of the comparator even if a load transistor 131 that constitutes the comparator (see FIG. 10) in the prior art example is shifted onto the vertical signal line.

The horizontal control line 6 is connected in common to the picture cells 17 of an identical row. Moreover, the reset select line 7 and the row select signal line 8 are connected in common to the picture cells 17 of the identical row. The horizontal control line 6, the reset select line 7 and the row select signal line 8 are connected to a vertical scanning circuit 72 that selects the picture cells 17 in units of rows. The variable voltage generation circuit 71 is connected to the vertical scanning circuit 72. A latch circuit 73 is connected to the output side of the comparator 10 of each column, and each latch circuit 73 is connected to one counter circuit 74. The latch circuit 73 and the counter circuit 74 constitute a pulse width modulation part.

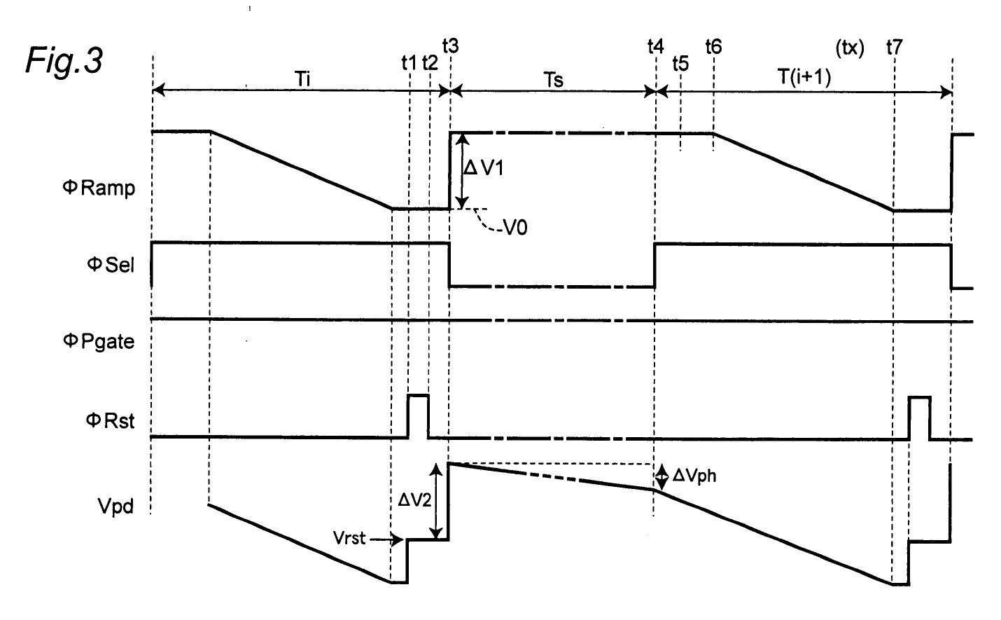

FIG. 3 shows operation timing when attention is paid to one picture cell 17 (assumed to be the picture cell of n-th row and m-th column, and hereinafter referred to as a “noticed picture cell”) of the solid-state imaging device. It is noted that FIG. 3 shows the operation timing from the beginning of an i-th frame signal reading period Ti through a signal charging period Ts to the end of a (i+1)-th frame signal reading period T(i+1) for the sake of simplicity.

As shown in FIG. 3, the row select pulse ΦSel goes H level to turn on the select transistor 5 with regard to the noticed picture cell 17 during the signal reading periods Ti and T(i+1), respectively, and the source grounded amplifier constructed of the transistor 2A of the noticed picture cell 17 and the load transistor 13 operates. On the other hand, since the row select pulse ΦSel goes L level to turn off the select transistor 5 during the signal charging period Ts, no source grounded amplifier is constituted.

Signal reading operation of the noticed picture cell 17 (assumed to be the picture cell of n-th row and m-th column) of the solid-state imaging device is described next following times t1, t2, . . .

First of all, a reset signal ΦRst for all the photodiodes 1 located on the n-th row rises at time t1 within the signal reading period Ti, turning on the reset transistor 4 of the comparator transistor 2A. As a result, the voltage Vpd at the node pd of the photodiode 1 is reset.

By turning on the reset transistor 4, the voltages at the input terminal and the output terminal of the comparator transistor 2A becomes equalized. Therefore, the voltage at the cathode electrode (node pd) of the photodiode 1 is reset to a reset voltage Vrst within the transition region of the comparator transistor 2A.

During the read operation of the solid-state imaging device, a variation component such that the voltage Vpd at the node pd varies from the reset voltage Vrst obtained by making a short circuit between the input terminal and the output terminal of the comparator transistor 2A in the picture cell is handled as a signal. Therefore, the read operation is not hindered even if the value of the reset voltage Vrst itself is varied every picture cell by manufacturing factors or the like.

Next, the resetting of the voltage Vpd at the node pd of the photodiode 1 ends at time t2 before the end of the signal reading period Ti.

Next, the row select pulse ΦSel goes L level to turn off the select transistor 5 at start time t3 of the signal charging period Ts. Moreover, a voltage ΦRamp of the horizontal control line 6 is raised by a voltage ΔV1 from a voltage V0 at time t3. The voltage ΦRamp is given from the variable voltage generation circuit 71 to the horizontal control line 6. The voltage ΔV1 is the first control voltage.

Since the node pd is in the floating state, assuming that the capacitance of the photodiode 1 is Cpd and the capacitance of the capacitor 3 located between the photodiode 1 and the horizontal control line 6 is Ccnt, then the voltage Vpd at the node pd of the photodiode 1 is raised by a voltage ΔV2 calculated by:
ΔV2=ΔV1·Ccnt/(Ccnt+Cpd) Equation (1)

In this case, by setting the voltage ΔV1 with a sufficiently great value, the voltage Vpd at the node pd of the photodiode 1 can be shifted in level to a place sufficiently separated from the transition region of the comparator transistor 2A.

The variable voltage generation circuit 71 makes the voltage Vpd at the node pd deviate from the transition region of the comparator transistor 2A via the capacitor 3 by applying the voltage ΦRamp to the horizontal control line 6. An optical signal charging state of the n-th row starts from the state.

During the signal charging period T2, electrons are generated from photons by photoelectric conversion in the photodiode 1, and the voltage Vpd at the node pd is lowered from (reset voltage Vrst+voltage ΔV2) in proportion to the quantity of incident light.

Although the case of charging of electrons by photoelectric conversion is described in the example, it may be a case of charging of holes by photoelectric conversion. In the case of charging of holes, the voltage Vpd at the node pd rises in proportion to the quantity of incident light.

Next, the row select pulse ΦSel goes H level to turn on the select transistor 5 at start time t4 of the signal reading period T(i+1) of the (i+1)-th frame. Therefore, the source grounded amplifier constructed of the transistor 2A of the noticed picture cell 17 and the load transistor 13 operates.

Assuming that the voltage Vpd at the node pd of the photodiode 1 is lowered by ΔVph during the optical signal charging, at time t5 immediately after the start of the signal reading period T(i+1), the voltage Vpd at the node pd of the photodiode 1 becomes the voltage calculated by:
Vpd=Vrst+ΔV2−ΔVph Equation (2)

Next, the variable voltage generation circuit 71 varies (lowers) the voltage ΦRamp of the horizontal control line 6 from the voltage at time t5 after the signal reading start time t4 at time t6 within the signal reading period T(i+1). Then, the voltage ΦRamp of the horizontal control line 6 is assumed to return to V0 at time t7. The voltage ΦRamp that the variable voltage generation circuit 71 applies to the horizontal control line 6 from time t6 to time t7 becomes a second control voltage.

When the voltage Vpd at the node pd reaches the reference voltage (threshold voltage) of the comparator transistor 2A during the interval from the time t6 to time t7, the output signal of the comparator transistor 2A is inverted. That is, when the voltage Vpd at the node pd of the photodiode 1 reaches the threshold voltage Vrst of the comparator transistor 2A during the interval from time t6 to time t7 (assumed to be tx), the output signal of the comparator transistor 2A is inverted from L level to H level.

The output signal of the comparator transistor 2A that has been inverted from L level to H level at time tx is transmitted to the column comparator 10 (see FIG. 2) connected to the end terminal of the vertical signal line 9 via the select transistor 5.

The counter circuit 74 connected to the output side of the column comparator 10 starts operating from the row read start time t4. At the row read start time t4, the vertical signal line 9 is reset to a vertical signal reset voltage Vr, and the vertical signal line 9 receives the output signal that changes from L level to H level from the noticed picture cell 17 at time tx. The output signal is inputted to the latch circuit 73 via the column comparator 10 and inputted from the latch circuit 73 to the counter circuit 74. The latch circuit 73 and the counter circuit 74 constitute a storage part.

The larger the quantity of incident light to the photodiode 1, the larger the amount ΔVph of voltage drop at the node pd. Therefore, according to Equation (2), the time necessary for the voltage Vpd at the node pd to reach the reset voltage Vrst due to the ramp wave of the voltage ΦRamp of the horizontal control line 6 during the signal reading period T1 becomes shorter as the quantity of incident light is larger. Therefore, by making the counter circuit 74 count down from time t4, the count value stored in the latch circuit 73 and the counter circuit 74 on the output side of the column comparator 10 can be made proportional to the quantity of incident light at time tx. That is, the count value can be obtained as a digital signal that is pulse width modulated by the quantity of incident light.

It is acceptable to connect a ramp ADC (analog-to-digital conversion) circuit to the output side of the column comparator 10 in place of the counter circuit 74 and make the ramp ADC circuit convert the H level signal inputted from the transistor 2A to the column comparator 10 at time tx through AD conversion.

In the solid-state imaging device, the signal reading is thus performed.

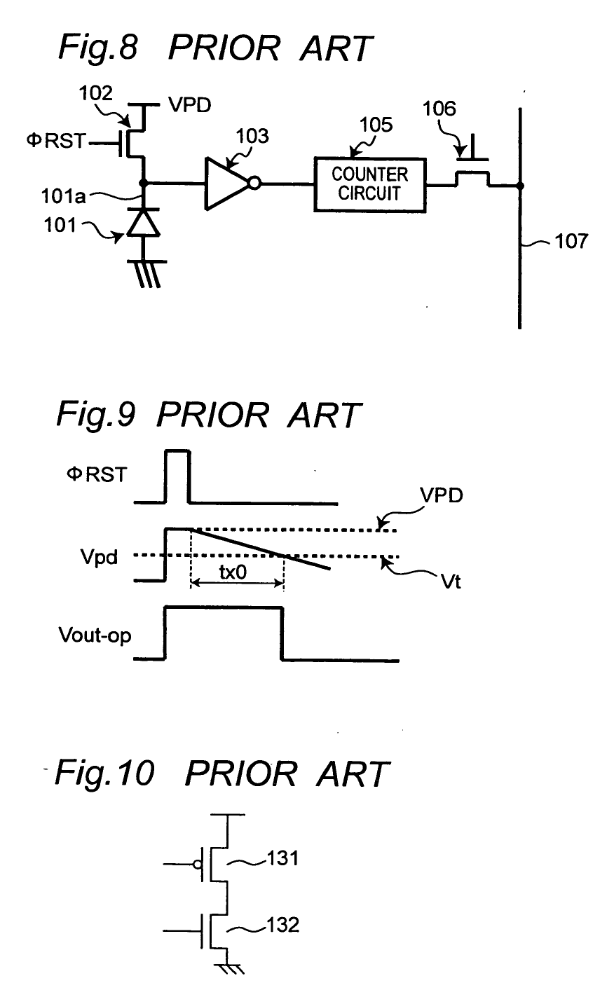

In the solid-state imaging device, the load transistor 13 for constituting the comparator part is not provided in each picture cell 17 but provided in common to the picture cells 17 of an identical column, i.e., in common to the comparator transistors 2A of a plurality of picture cells 17 arranged along an identical vertical signal line 9. Therefore, the construction of the picture cells 17 can be simplified in comparison with those of the solid-state imaging device of the prior art example (FIG. 8).

That is, although the comparator in the picture cell has been constructed of two MOS transistors in the prior art example, it is possible to eliminate the load transistor as well as the bias signal line and the power voltage line connected to its gate in each picture cell if the comparator part is constructed of one MOS transistor according to the present invention. That is, one transistor and two wiring lines can be eliminated. Therefore, areal reduction of the solid-state imaging device becomes possible.

### Second Embodiment

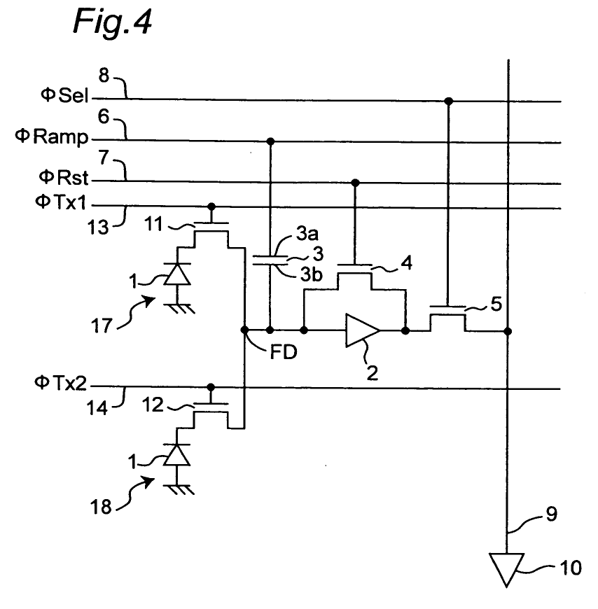

FIG. 4 shows the construction of the pulse width modulation type solid-state imaging device of the second embodiment of the present invention. It is noted that FIG. 4 shows only two picture cells 17 and 18 arranged along the vertical signal line 9 among a number of picture cells arranged in a matrix form owned by the solid-state imaging device for the sake of simplicity.

In the solid-state imaging device, the capacitor 3, the comparator 2, the reset part and the select switch element are common to the two picture cells 17 and 18 arranged along the vertical signal line 9. Transfer switching elements 11 and 12 are interposed between the output terminals of the photoelectric conversion portions 1 and 1 of the picture cells 17 and 18 and the photoelectric conversion portion side terminal 3b of the capacitor 3. These transfer switch elements 11 and 12 are controlled to be turned on and off by transfer control signals ΦTx1 and ΦTx2 of transfer lines 13 and 14 and become conductive when the respectively corresponding photodiodes 1 are selected. In the example, the drain terminals of the transfer switch elements 11 and 12 are connected in common to each other and indicated as a node FD connected to the terminal 3b of the capacitor 3 and the input terminal of the comparator 2.

In the example, the comparator 2 is constructed of the p-channel type MOS transistor 131 and the n-channel type MOS transistor 132 shown in FIG. 10. The other constructions of the picture cells 17 and 18 are similar to those of FIG. 1.

Signal reading operation of the noticed picture cells 17 and 18 (assumed to be the picture cells of n-th row and m-th column and (n+1)-th row and m-th column, respectively) of the solid-state imaging device is described next following times t1, t2, . . .

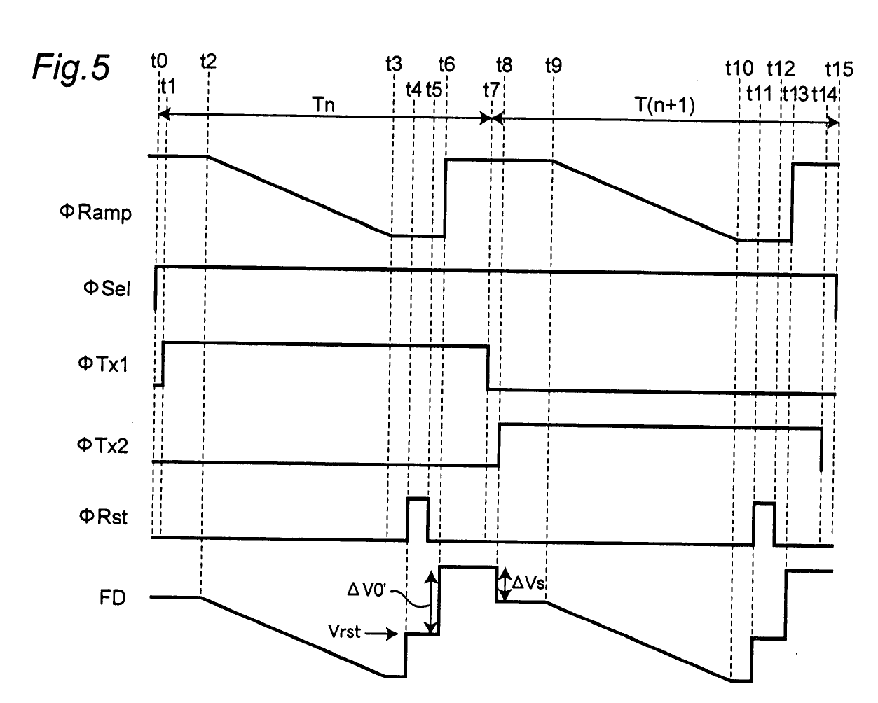

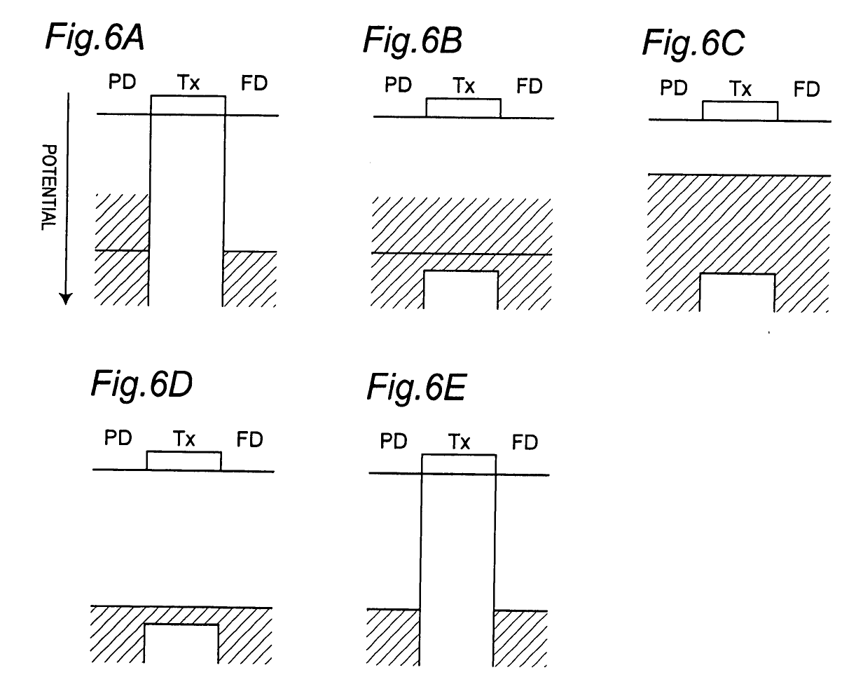

FIG. 5 is a timing chart for explaining the signal reading operation in a certain frame of the solid-state imaging device. In FIG. 5, Tn indicates the read period of the n-th row in the frame, and T(n+1) indicates the read period of the subsequent (n+1)-th row. FIGS. 6A through 6E show potential profiles of the photodiode 1 (hereinafter properly referred to as “PD”) to the node FD at each time of times t0 through t9 in the timing chart of FIG. 5. In concrete, PD, Tx and FD in FIG. 6A through 6E indicate the cathode region of the photodiode 1, the channel region of the transfer transistor 11 and the potential profile at the node FD, respectively.

First of all, a row select signal ΦSel applied to the gate of the select transistor 5 goes H level at time t0. At time t0, as shown in FIG. 6A, the photodiode 1 is charged with signal charge (illustrated by hatched lines) generated through photoelectric conversion. At this time, the potential of the channel region of the transfer transistor 11 is in a shallow state, and therefore, PD and FD are nonconductive.

Next, the transfer control signal ΦTx1 applied to the gate of the transfer transistor 11 goes H level at time t1 to start the read operation of the picture cell 17 of the n-th row. At time t1, as shown in FIG. 6B, the potential of the channel region of the transfer transistor 11 is deep, and PD and FD are conductive.

Assuming herein that a capacitance at PD is Cpd, a stray capacitance at FD is Cfd, a change in the voltage at PD due to light incidence during the charging period is ΔVs and the voltage at FD before time t1 is Vrst, then the voltage V1 at FD at time t1 becomes
V1≈Vrst+V0′+Cpd/(Cpd+C0)·ΔVs
when Cfd<<Cpd, and the voltage at PD is stored in FD. Reference will be made to V0′ later.

The voltage ΦRamp of the horizontal control line 6 starts changing at time t2, i.e., the ramp wave is applied, starting picture cell signal reading. The voltage at FD also varies via the capacitor 3 as the ramp wave varies. In this case, Vrst is assumed to be a reset voltage when the input/output terminals of the comparator 2 are short-circuited. Moreover, ΦV0′ is assumed to be a voltage change at FD via the capacitor 3 due to the ramp wave.

Then, the voltage Vsig at FD at time t2 can be expressed as:
Vsig=Vrst+ΔV0′−ΔVs(herein, ΔV0′>ΔVs)

When the voltage at FD reaches Vrst at time tx, the output signal of the comparator 2 changes from L level to H level. The change in the output signal of the comparator 2 is transmitted to the column comparator 10 through the select transistor 5.

Because the amount of voltage change due to the ramp wave at time tx is (tx−t2)/(t3−t2)·ΔV0′, tx is calculated as follows.
(tx−t2)/(t3−t2)·ΔV0′=ΔV0′−ΔVs
tx−t2=(t3−t2)/ΔV0′·(ΔV0′−ΔVs)
tx=t2+(t3−t2)/ΔV0′·(ΔV0′−ΔVs)

The pulse width that causes the inversion of the output signal is (t3−t2)/ΔV0′·(ΔV0′−ΔVs), which depends on the quantity ΔVs of incident light. When the quantity of incident light is 0 (That is, ΔVs=0), the output signal is inverted at time t3 at the terminal end of the ramp wave. Moreover, the maximum quantity of sensible incident light is located at time tx=t2 (ΔVs=ΔV0′), when the output signal is inverted with the start of the ramp wave.

Next, the voltage ΦRamp of the horizontal control line 6 is changed between times t2 and t3, and time tx when the output of the comparator 2 is inverted from L level to H level in accordance with the quantity of signal charge in the internal photodiode 1 changes. As a result, the pulse width of the output signal is to vary in accordance with the quantity of incident light, and an output signal that has undergone pulse width modulation is obtained.

Next, the reset signal ΦRst applied to the gate of the reset transistor 4 has H level from time t4 to t5, and the input and output terminals of the comparator 2 are short-circuited and made to have the reset voltage Vrst. As a result, the voltages at PD and FD are reset as shown in FIG. 6C.

Next, when the voltage ΦRamp of the horizontal control line 6 is raised by ΔV0 at time t6, and the voltages at PD and FD are made to deviate from the driving range of the comparator 2, providing a charging start state. Assuming that the capacitance of the capacitor 3 is C0, then a voltage variation ΔV0′ at FD can be expressed as:
ΔV0′=ΔV0·C0/(C0+Cpd)

At time t6, the voltages at PD and FD make a transition to (Vrst+ΔV0′). Potential profiles at PD and FD at this time shift from FIG. 6C to 6D.

Next, the transfer control signal ΦTx1 goes L level at time t7, and PD and FD of the picture cell 17 of the n-th row become nonconductive as shown in FIG. 6E. As a result, the charging state of the picture cell 17 of the n-th row is started.

Next, the transfer control signal ΦTx2 applied to the gate of the transfer transistor 12 of the picture cell 18 of the (n+1)-th row goes H level at time t8, starting reading the picture cell 18 of the (n+1)-th row. From time t10 to t14, signal reading of the picture cell of the (n+1)-th row is carried out as in the signal reading of the picture cell 17 of the n-th row. Then, the row select signal ΦSel applied to the gate of the select transistor 5 goes L level at time t15. As a result, signal reading of the n-th row and the (n+1)-th row sharing the capacitor 3 and the comparator 2 ends.

In the solid-state imaging device, the capacitor 3, the comparator 2, the reset part and the select switch element are common to the two picture cells 17 and 18 arranged along the vertical signal line 9 as described above. Therefore, the constituent elements can be reduced, and areal reduction of the solid-state imaging device becomes possible as a whole.

In concrete, by constituting one capacitance amplifier of two picture cells as described above, the transistor count per picture cell becomes three and the capacitor count per picture cell becomes 0.5. This allows the picture cell to be reduced in size in comparison with the case where the transistor count per picture cell is four and the capacitor count per picture cell is one when they are not shared.

Although the comparator, the capacitor and so on are shared by the two picture cells 17 and 18 arranged along the vertical signal line 9 in the embodiment, the number of shared picture cells is not limited to two, and it is acceptable to share the comparator, the capacitor and so on by a greater number of picture cells.

### Third Embodiment

As a driving method in the case of a construction that has the pulse width modulation type solid-state imaging device shown in FIG. 4, a read method for obtaining an average of the picture cell signal of the n-th row and the picture cell signal of the (n+1)-th row can be considered.

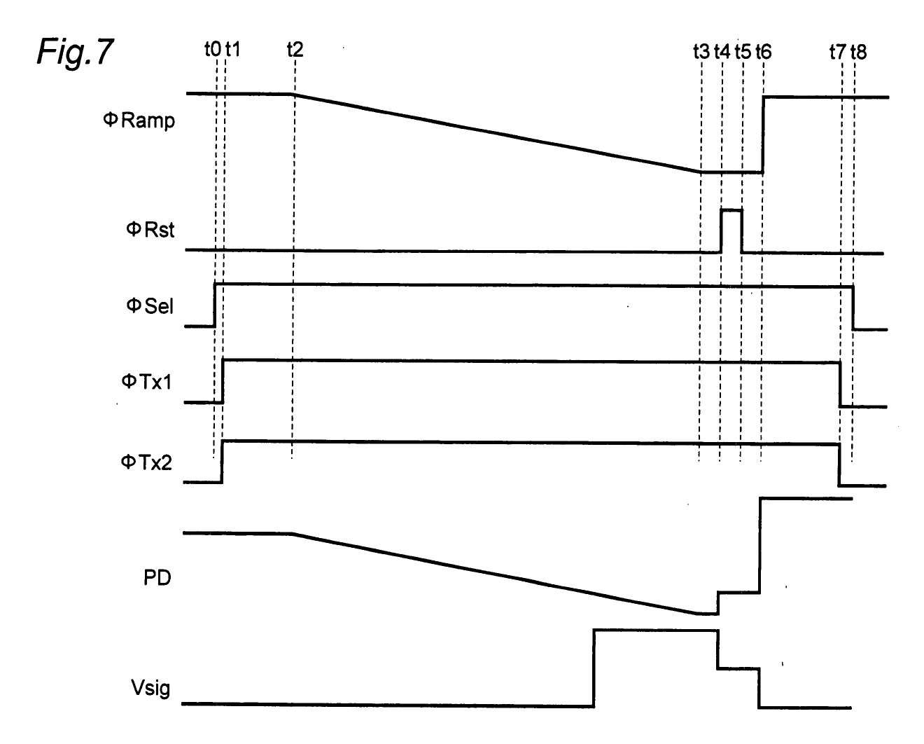

FIG. 7 is an operation timing chart in the case where such a signal reading method is carried out. In contrast to the signal reading method described in the second embodiment in which the transfer control signals ΦTx1 and ΦTx2 successively have H level between the two picture cells 17 and 18 arranged along the vertical signal line 9 to successively read the signals from the picture cells 17 and 18, the present read method makes the transfer control signals ΦTx1 and ΦTx2 simultaneously have H level between the two picture cells 17 and 18 to simultaneously read the signals from picture cells 17 and 18 to the node FD.

In concrete, by making the transfer control signals ΦTx1 and ΦTx2 applied to the transfer transistor 11 of the n-th row and the transfer transistor 12 of the (n+1)-th row have H level at time t1, the PD's and FD's of the picture cells 17 and 18 are made conductive. Assuming that the voltage and the capacitance at PD of the picture cell 17 are Vsig1 and Cpd1, respectively, and the voltage and the capacitance at PD of the picture cell 18 are Vsig2 and Cpd2, respectively, at time t0, then the voltage Vsig at FD at time t1 is expressed as:
Vsig=(Cpd1·Vsig1+Cpd2·Vsig2)/(Cpd1+Cpd2)
Assuming that the capacitances Cpd1 and Cpd2 at PD's of the two picture cells 17 and 18 are equal to each other and Cpd, then the equation:
Vsig=(Vsig1+Vsig2)/2
holds. That is, (Vsig) is obtained at the node FD by averaging the picture cell signal Vsig1 of the n-th row and the picture cell signal Vsig2 of the (n+1)-th row.

Read operation is carried out from subsequent time t2 to time t7 according to the same procedure as described in the second embodiment. Then, the row select signal ΦSel applied to the gate of the select transistor 5 goes L level at time t8. As a result, the signal reading of the n-th row and the (n+1)-th row sharing the capacitor 3, the comparator 2 and so on ends.

The signal reading method described in the third embodiment averages the image signals of n-th row and the (n+1)-th row sharing the capacitor 3, the comparator 2 and so on and is able to perform the signal reading of the n-th row and the (n+1)-th row in a half time in comparison with the signal reading method described in the second embodiment. Therefore, the reading speed of one frame can be increased by compressing the image in the direction of column.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A solid-state imaging device comprising:
a plurality of picture cells arranged; and
a signal line, which is provided in common to the picture cells and from which a signal from each of the picture cells is outputted, wherein each of the picture cells comprises:
a photoelectric conversion portion that photoelectrically converts incident light;
a capacitive element connected between an output terminal of the photoelectric conversion portion and a control line;
a comparator portion, which compares an output voltage of the photoelectric conversion portion with a prescribed reference voltage and outputs an output signal that represents a result of the comparison;
a reset portion, which is connected to the output terminal of the photoelectric conversion portion and discharges a signal charge generated by the photoelectric conversion portion; and
a select switch element, which is connected between an output terminal of the comparator portion and the signal line and becomes conductive when the picture cell is selected, and
the device comprises:
a control voltage application portion, which applies a first control voltage to the control line during a signal charging period to make a voltage of the output terminal of the photoelectric conversion portion deviate from a transition region of the comparator portion and applies a second control voltage to the control line during a signal reading period to bring the voltage of the output terminal of the photoelectric conversion portion into the transition region of the comparator portion; and
a load device, which is connected between the signal line and a power source of a prescribed voltage and serves as a common load for the comparator portions of the picture cells.

2. A solid-state imaging device comprising:
a plurality of picture cells arranged; and
a signal line, which is provided in common to the picture cells and from which a signal from each of the picture cells is outputted, wherein
each of the picture cells comprises:
a photoelectric conversion portion that photoelectrically converts incident light;
a capacitive element whose one end is connected to a control line;
a transfer switch element, which is connected between the other end of the capacitive element and an output terminal of the photoelectric conversion portion and made conductive to select the photoelectric conversion portion;
a comparator portion, which is connected to the other end of the capacitive element and compares an output voltage of the photoelectric conversion portion received via the transfer switch element with a prescribed reference voltage and outputs an output signal that represents a result of the comparison;
a reset portion, which is connected to the output terminal of the photoelectric conversion portion and discharges a signal charge generated by the photoelectric conversion portion;
a select switch element, which is connected between an output terminal of the comparator portion and the signal line and becomes conductive when the picture cell is selected, and
the device comprises:
a control voltage application portion, which applies a first control voltage to the control line during a signal charging period to make a voltage of the output terminal of the photoelectric conversion portion deviate from a transition region of the comparator portion and applies a second control voltage to the control line during a signal reading period to bring the voltage of the output terminal of the photoelectric conversion portion into the transition region of the comparator portion, and
the capacitive element, the comparator portion, the reset portion and the select switch element are common to the prescribed number of picture cells arranged along the signal line.

3. A driving method for driving the solid-state imaging device claimed in claim 2, wherein
the select switch element common to the prescribed number of picture cells is turned on for a prescribed period and the transfer switch element for the prescribed number of picture cells is simultaneously turned on within the period in order to output the output signal from the prescribed number of picture cells onto the signal line.

4. The solid-state imaging device as claimed in claim 1, comprising:
a pulse width modulation portion, which obtains a pulse width modulation signal by subjecting the output signal outputted from each of the picture cells onto the signal line to analog-to-digital conversion.

5. The solid-state imaging device as claimed in claim 2, comprising:
a pulse width modulation portion, which obtains a pulse width modulation signal by subjecting the output signal outputted from each of the picture cells onto the signal line to analog-to-digital conversion.
